(19) United States
(12) Patent Application Publication
(10) Pub. No.: US 2012/0179965 A1
(43) Pub. Date: Jul. 12, 2012

(54) GESTURE-BASED NAVIGATION SYSTEM FOR A MOBILE DEVICE

(76) Inventor: Whitney Taylor, San Francisco, CA (US)

(21) Appl. No.: 13/348,261

(22) Filed: Jan. 11, 2012

Related U.S. Application Data
(60) Provisional application No. 61/431,927, filed on Jan. 12, 2011.

(51) Int. Cl. G06F 3/01

(52) U.S. Cl. 715/705

(57) ABSTRACT

Systems and methods to facilitate the navigation of functions of an application of a mobile device using a gestural input scheme. A navigation scheme based on simple user-initiated gestures reduces the safety hazards and physical challenges that are introduced when interacting with a mobile device in the wild. A mobile device having a motion sensor is programmed with an application that allows a user to navigate between the various functions (e.g., features, screens, and menu options) of the application by moving the mobile device according to predefined gestures. The motion sensor in the mobile device senses a user gesture imposed on the mobile device and the application on the mobile device responds to the gesture by navigating to the function that is correlated to the gesture as part of the application.

This U.S. Patent Application claims priority to and the benefit of U.S. provisional patent application Ser. No. 61/431,927 filed on Jan. 12, 2011, which is incorporated herein by reference in its entirety.

### TECHNICAL FIELD

Certain embodiments of the present invention relate to mobile devices. More particularly, certain embodiments of the present invention relate to systems and methods to facilitate the navigation of features of an application of a mobile device using a gestural input scheme.

### BACKGROUND

Today, trying to operate a mobile device outside of a clean and controlled environment, such as the home or office, can be challenging. In these less than ideal environments, such as at ski resorts, near lakes and rivers, or in muddy terrain, traditional interaction between the user and the device is greatly hindered due to the adaptations that mobile devices require in these environments. Usability issues arise due to an array of factors such as inclement weather, weatherproof and protective mobile phone casings, bulky gear or gloves worn by users, and safety hazards encountered within the environment. For example, ski and snowboarders often access their mobile devices on snowy mountains while wearing gloves. Capacitive touch screens on mobile devices cannot be triggered through standard gloves, so users are forced to take off their gloves to operate applications on their mobile touchscreen devices. Touching the screen in such an environment is also not ideal, considering that a user's hands may be dirty, cold, and/or wet, and the mobile device could be damaged by exposing it to such elements within these less than ideal environments. For these reasons, traditional touch navigation for mobile applications proves ineffective in less than ideal environments, referred to as “wild environments” herein. Therefore, a need exists for an alternative navigation system to facilitate the navigation of application features in less than ideal environments and to overcome the usability issues discussed herein.

Further limitations and disadvantages of conventional, traditional, and proposed approaches will become apparent to one of skill in the art, through comparison of such systems and methods with embodiments of the present invention as set forth in the remainder of the present application with reference to the drawings.

### SUMMARY

Embodiments of the present invention facilitate the navigation of application features on a mobile device based on user-initiated gestures, thus removing the safety hazards, difficulty, and annoyance of having to remove gloves or touch the mobile screen in less ideal environments referred to herein as “wild environments”. Furthermore, embodiments of the present invention allow for mobile devices to be operated while completely sealed in a protective case, since touch input on the screen is no longer necessary. This helps protect the mobile device in less than ideal environments such as on construction sites or during on-the-go activities such as snowboarding, fishing, biking, kayaking, walking, etc. The gesture navigation scheme also allows for the device to be operated with one hand, which is often necessary in wild environments and during on-the-go-activities where only one hand is free to operate the mobile device, while the other hand is used to carry gear or other equipment. Embodiments of the present invention are primarily intended for wild environments, outside the home or office, but may also be used in clean, controlled, ideal environments like the home or office as well.

An embodiment of the present invention comprises a method implemented in a software application on a mobile device providing a gesture navigation scheme. The method includes displaying representations of selectable functions of the software application on a user interface of the mobile device so as to intuitively cue a user as to which gestures of a plurality of defined gestures to impose upon the mobile device to navigate through the selectable functions. The method further includes sensing a defined first gesture imposed upon the mobile device by a user of the mobile device, and matching the first gesture to a first function of the selectable functions provided by the mobile device in accordance with an intuitive cueing of the user by the displayed representations. The method also includes navigating to the first function of the selectable functions in response to the matching as indicated by a displayed representation of the first function on the user interface of the mobile device. The method may further include selecting the first function on the mobile device in response to the user imposing a defined selection gesture on the mobile device. The method may also include sensing a defined second gesture imposed on the mobile device by a user of the mobile device, and matching the second gesture to a second function of the selectable functions provided by the mobile device in accordance with an intuitive cueing of the user by the displaying. The method may further include navigating to the second function of the selectable functions in response to the matching as indicated by a displayed representation of the second function on the user interface of the mobile device. The method may further include selecting the second function on the mobile device in response to the user imposing a defined selection gesture on the mobile device. The selectable functions of the software application may provide functionality to aid at least one of a skier user and a snowboarding user at an outdoor facility. As such, the selectable functions may correspond to one or more of a map functionality of the software application, a friend-locating functionality of the software application, a local information functionality of the software application, a camera functionality of the software application, and a weather information functionality of the software application.

Another embodiment of the present invention comprises a mobile device providing a gesture navigation scheme. The mobile device includes at least one motion sensor configured to sense one or more defined gestures imposed upon the mobile device by a user of the mobile device. The motion sensor may include, for example, an accelerometer or a gyroscope. The mobile device further includes a processing element operatively configured to receive data indicative of the sensed gestures from the at least one motion sensor. The processing device may include, for example, a programmable microprocessor. The mobile device also includes a software application configured to operate on the processing element to provide selectable functions, and a display screen operatively configured to display information produced by the software application as the software application operates on the processing element. The display screen may include, for example, a liquid crystal display (LCD) screen or a light-emitting diode (LED) display screen. The software application is further configured to display representations of the selectable functions on the display screen to intuitively cue a user as to which of the defined gestures to impose on the mobile device to navigate to a desired function of the selectable functions. The software application is also further configured to correlate the sensed gestures, as represented by the received data, to the selectable functions in accordance with the intuitive cueing of the user by the displayed representations. The mobile device may also include a global positioning system (GPS) receiver operatively configured to provide GPS location information to the processing element. The selectable functions of the software application may provide functionality to aid at least one of a skier user and a snowboarding user at an outdoor facility. The selectable functions may correspond to one or more of a map functionality of the software application, a friend-locating functionality of the software application, a local information functionality of the software application, a camera functionality of the software application, and a weather information functionality of the software application. The mobile device may include a computer memory for storing, for example, computer-readable instructions of the software application. The mobile device may also include a protective housing configured to protect the elements (e.g., the motion sensor, the processing element, the display screen, the GPS receiver, the computer memory) of the mobile device from environmental factors such as, for example, moisture, vibration, shock, heat, and cold.

A further embodiment of the present invention comprises a non-transitory computer-readable medium having computer-executable instructions of a software application recorded thereon. The computer-executable instructions are capable of being executed on a processing element of a mobile device and providing a gesture navigation scheme on the mobile device. The instructions include instructions providing selectable functions of the software application. The instructions also include instructions for displaying representations of the selectable functions of the software application on a user interface of the mobile device so as to intuitively cue a user as to which gestures of a plurality of defined gestures to impose upon the mobile device to navigate through the selectable functions. The instructions further include instructions for identifying a defined gesture imposed upon the mobile device by a user of the mobile device, and instructions for matching the identified gesture to a first function of the selectable functions provided by the software application in accordance with an intuitive cueing of the user by the displayed representations. The instructions also include instructions for navigating to the first function of the selectable functions in response to the matching as indicated by a displayed representation of the first function on the user interface of the mobile device. The instructions may further include instructions for selecting the first function on the mobile device in response to the user imposing a defined selection gesture on the mobile device. The selectable functions of the software application may provide functionality to aid at least one of a skier user and a snowboarding user at an outdoor facility. The selectable functions may correspond to one or more of a map functionality of the software application, a friend-locating functionality of the software application, a local information functionality of the software application, a camera functionality of the software application, and a weather information functionality of the software application.

These and other advantages and novel features of the present invention, as well as details of illustrated embodiments thereof, will be more fully understood from the following description and drawings.

### BRIEF DESCRIPTION OF THE DRAWINGS

FIG. 1 illustrates a navigational flow diagram of an exemplary embodiment of functions of a mobile application implemented on a mobile device;

FIG. 2 illustrates an exemplary embodiment of the gestures within a navigational scheme of the mobile application of FIG. 1, the axes of the mobile device that the gestures affect, and the user interface elements that the gestures control;

FIG. 3 illustrates an exemplary embodiment of the gestural vocabulary associated with the gestural navigation scheme of FIG. 2;

FIG. 4 illustrates an exemplary embodiment of a front view of a mobile device running the mobile application of FIG. 1 and being used in an augmented reality map view of the mobile application;

FIG. 5 illustrates an exemplary embodiment of a front view of a mobile device running the mobile application of FIG. 1, and being used in an augmented reality friends view of the mobile application;

FIG. 6 illustrates an exemplary embodiment of a user interface used in collaboration with the gestural navigation system and how the user interface responds in an accordion type manner based on the gestures initiated by the user;

FIG. 7 illustrates an exemplary embodiment of a front view of a mobile device completely sealed in a protective case, being operated by a user wearing gloves, while running the mobile application of FIG. 1, and being used in an augmented reality camera view of the application;

FIG. 8 illustrates an exemplary embodiment of a view seen when the application of the mobile device is put into a desktop mode, where touch navigation is the primary input mechanism;

FIG. 9 illustrates an exemplary embodiment of two views displayed when the mobile device is put in a desktop mode verse a gestural mode, which is determined by the z-axis tilt of the mobile device;

FIG. 10 illustrates an exemplary embodiment of a front view of a mobile device being operated with one hand, running the mobile application of FIG. 1, and being used in an augmented reality map view of the application;

FIG. 11 illustrates a schematic block diagram of an exemplary embodiment of a mobile device configured to run the mobile application of FIG. 1; and

FIG. 12 is a flowchart of an exemplary embodiment of a method implemented in a software application on a mobile device providing a gesture navigation scheme.

### DETAILED DESCRIPTION

The mobile input scheme used to navigate user interface elements described herein is an alternative navigation method for mobile devices that limits touch interaction by providing a gestural input scheme. To navigate through the mobile application interface, a user simply holds the mobile device (e.g., a mobile phone) in portrait mode, pointing the camera of the mobile device towards the horizon and tilts the mobile phone left and right, bumping through the main functional categories/screens of the application. The interface screens fall left to right, folding and unfolding like an accordion style menu system, as the user tilts the phone left or right accordingly. Once a user has settled on a desired screen, the user can then sort through more in-depth options or functional subviews within that screen by tilting the phone forward or backward. To lock in on an item or perform a select type input, the user simply shakes the phone (a defined selection gesture). In accordance with other embodiments of the present invention, the tilting forward and backward may provide the functionality of bumping through the main views/categories/screens of the application, and tilting left and right may provide the functionality of sorting through in-depth options or subviews. Other implementations are possible as well, in accordance with other embodiments of the present invention. Embodiments of the present invention provide the direct and intuitive correlation between the gestures performed and the reaction of the user interface to those gestures.

The navigation system is based on gestures, so no touch interaction is needed other than for the initial launching of the application. Touch capability can be completely removed from an application operating on the gestural navigation scheme if a predefined gesture or a predefined combination of gestures is added into the programming of the navigation scheme for the application to allow for the unlocking of the mobile device lock screen, awaking the mobile device or application from a sleep mode, or to launch the specific application. For environments that do facilitate touch interaction, or if touch interaction is desired for specific features or attributes of an application, the user may switch from the gesture navigation scheme (gestural mode) to that of the standard touch navigation scheme of many mobile devices (desktop mode) by simply tilting the mobile phone downward until the side of the device opposite the screen is flat to the ground. This touch interaction mode is optional and has been made available within the gestural navigation scheme, but is not necessary if gestural interaction is the only desired or possible input mechanism for the environment and activity at hand. The desktop mode switches the phone into a traditional touch input mode of mobile devices, which is referred to herein as the “desktop mode”. The gestures that are initiated by the user are sensed by a motion sensor (e.g., an accelerometer or a gyroscope) of the mobile device and are correlated within the user interface to various functions (e.g., views, subviews, selection) of the mobile application. The user interface associated with the application gives the user intuitive and direct feedback based on the gesture performed.

As used herein, the term “function”, and derivations thereof, is used broadly and may refer to views, subviews, categories, subcategories, menu options, and actions of a software application operating on a mobile device. Also, the terms “mobile device” and “mobile phone” are used interchangeably herein. However, the term “mobile device” is not limited to a “mobile phone” herein. The concept of “intuitive cueing”, as used herein, refers to a user being readily able to understand which gesture or gestures to make to navigate to a function of a software application of a mobile device simply by observing the spatial relationships of the displayed portions of the user interface of the mobile device.

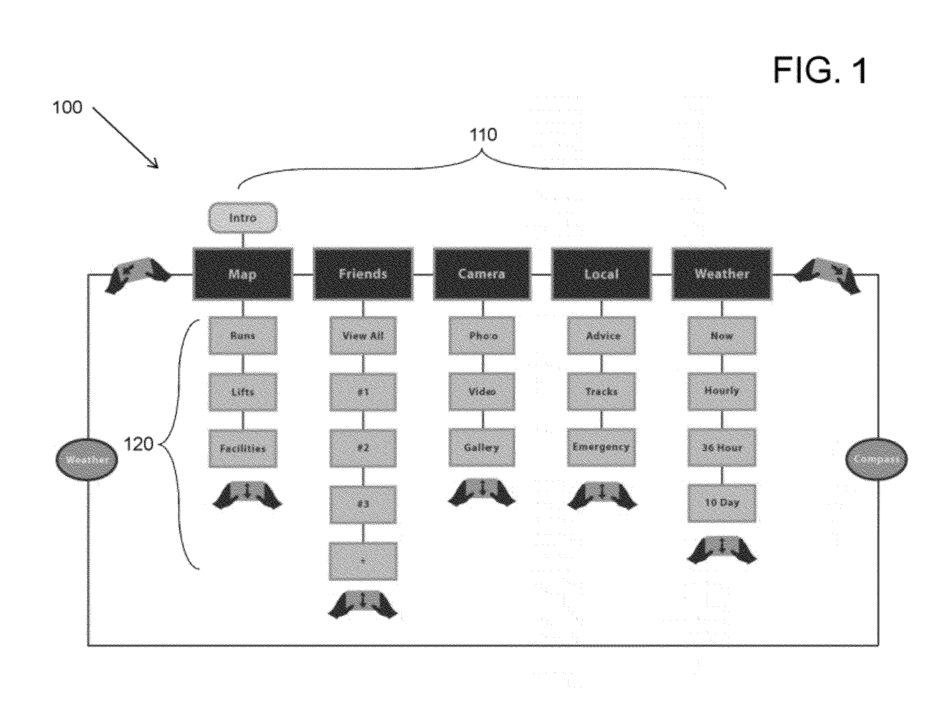

FIG. 1 illustrates a navigational flow diagram of an exemplary embodiment of functions of a mobile application 100 implemented on a mobile device. The mobile application 100 is intended to be used by skiers and snowboarders on ski slopes. However, the gesture-based functionality of other embodiments of the present invention is not limited to such a mobile application 100 for skiers and snowboarders. Other applications which use the gesture navigation functionality are possible as well. FIG. 1 shows the screens (views) 110 and features (subviews) 120 that are available within the example application 100. The gesture navigation capability of an embodiment of the present invention is used to navigate between the functional screens and features, and the tilting gestures are shown next to the functional screens and features themselves on the diagram of FIG. 1. Relatively simple options are provided to the user of a mobile device running an application using the gesture navigation capability, as only information viewable through gesture navigation is possible to display and navigate while the mobile device is used in the gestural mode.

The mobile application 100 is organized to provide several functions including an introduction (loading screen) function, a map function, a friend function, a camera function, a local advice function, and a weather function. Other functions are possible as well, in accordance with various embodiments of the present invention. For example, a compass function and a weather function may be used in conjunction with, for example, the map function and the friends function. The compass function may display an icon that shows the direction “North”, and the weather function may display an icon that shows the current state of the weather (e.g., sunny, cloudy, snowy, rainy, etc.) and the temperature. In accordance with an embodiment of the present invention, the layout of the functions of the mobile application 100 shown in FIG. 1 correlates to the gestures that are used to navigate through the various screens provided by the user interface, as is discussed later herein in more detail.

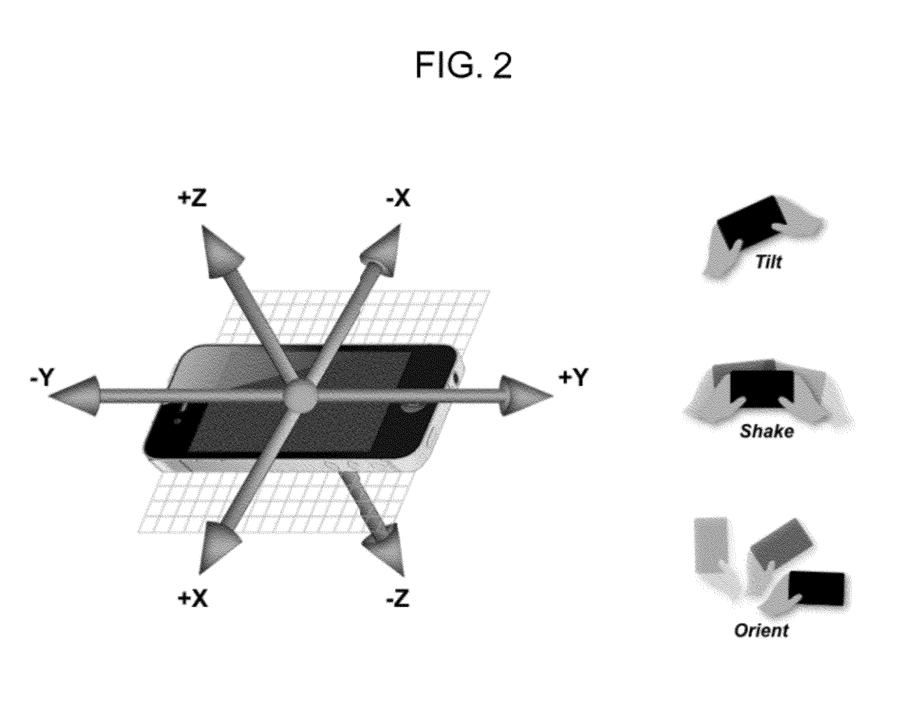

FIG. 2 illustrates an exemplary embodiment of the gestures within the gestural navigation scheme of the mobile application of FIG. 1, the axes (x.y.z) of the mobile device that the gestures affect, and the user interface elements (corresponding to mobile application functions) that the gestures manipulate. Tilting the mobile device left and right navigates between the main functional screens of the user interface, while tilting forward and back bumps between the functional subcategories within each functional screen. Shaking the mobile device performs a select type input (a defined selection gesture), and tilting the mobile device on its z-axis switches the navigation between gestural mode and desktop (touch) mode. In gestural mode, the navigation scheme relies solely on gestures, and can be operated with gloves on while the mobile device is completely sealed within a protective case. When the device is held in desktop mode, the device relies on touch interaction as the primary input mechanism. The desktop mode is meant for environments that facilitate touch interaction. Not all wild environments are the same, so the navigation scheme is not limited solely to gestural input, or solely to touch. Depending on the situation, application type, and environment at hand, the most appropriate interaction model (gestural or touch) can be decided by the user.

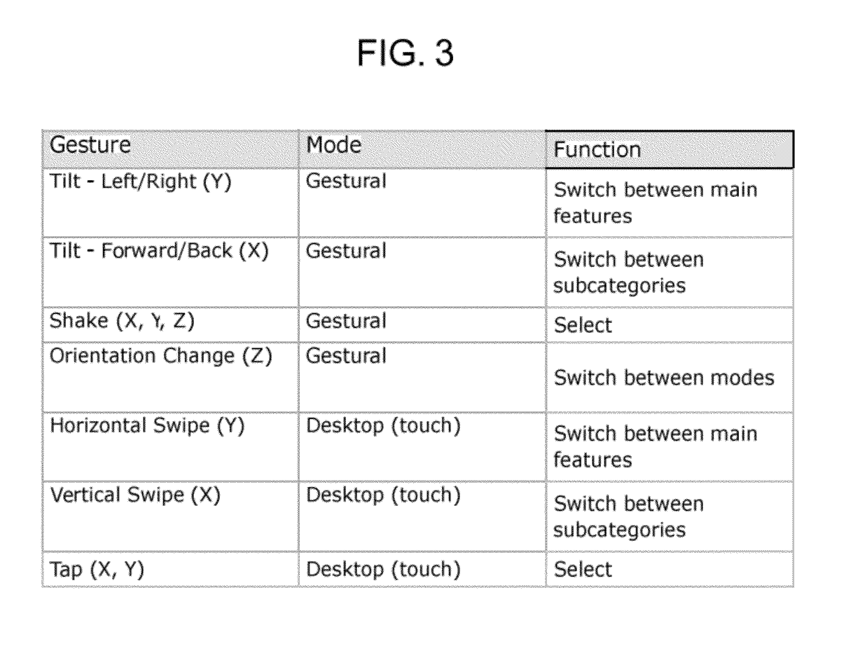

FIG. 3 illustrates an exemplary embodiment of the gestural vocabulary associated with the gestural navigation scheme of FIG. 2. The table is broken into the action performed (i.e., gesture), mode of interaction, and the function displayed within the user interface based on the gesture performed. Tilts and shakes are the input methods used while the mobile device is held in the gestural mode. Vertical swipes and taps (touch) are the input methods used while the mobile device is held in the desktop mode. Tilting the mobile device left and right in the gestural mode is equivalent to swiping left and right in the desktop mode. Tilting the mobile device forward and backward in the gestural mode is equivalent to swiping the screen vertically up and down in the desktop mode. Shaking the device in gestural mode is equivalent to tapping the screen in desktop mode. Orientation changes affecting the z-axis of the mobile device are used in both modes to switch to the other mode. Z-axis changes put the navigation scheme into desktop mode when the side opposite the screen of the mobile device is held flat to the ground. Z-axis changes put the device into gestural (touch) mode when the side opposite the screen of the mobile device is held perpendicular to the ground.

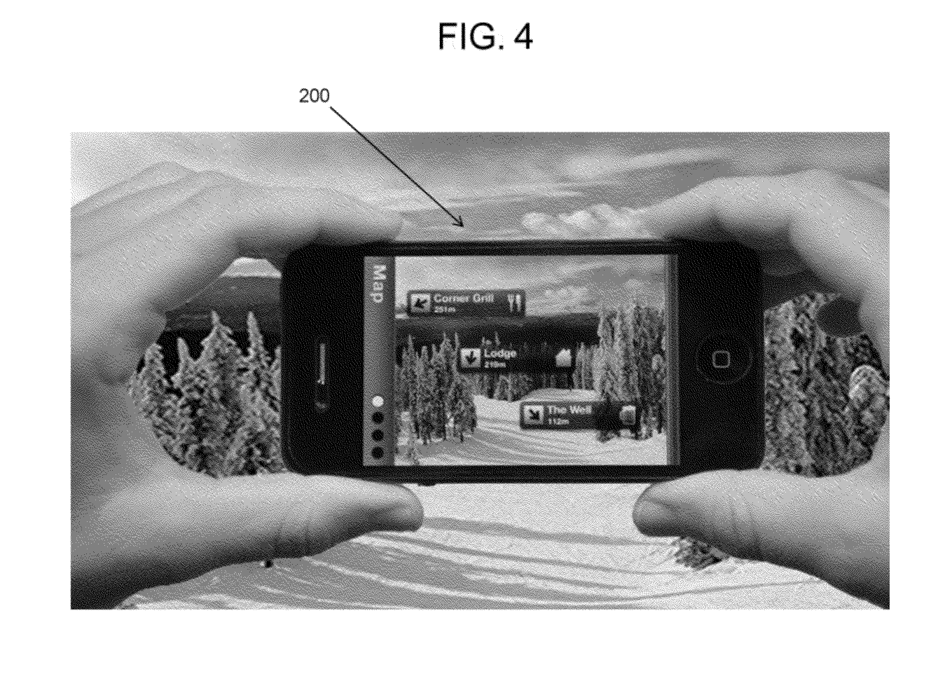

FIG. 4 illustrates an exemplary embodiment of a front view of a mobile device 200 running the mobile application 100 of FIG. 1, and being used in a functional map view of the mobile application 100. In FIG. 4, a user is holding the mobile device 200 such that the camera of the mobile device is pointing to the horizon of an outdoor environment and providing real time video on the display of the mobile device 200. This technique of overlaying graphics on real time video is called augmented reality. In the map view of the application 100, graphics are overlaid onto the displayed video creating an augmented view. The map view in FIG. 4 is showing, via graphic overlay, where the various ski resort facilities (e.g., Corner Grill, Lodge, The Well) are located. In accordance with an embodiment of the present invention, a GPS capability of the mobile device 200 may be used by the application 100 to properly position the ski resort facility graphics on the display screen based on the relative position between the user and the ski resort facility.

In the map view, as seen in FIG. 4, the user may use forward and backward gestures (i.e., tilt the mobile device forward and backward) to move from one functional subview to the next. For example, the map screen subviews include a ski run subview, a ski lifts subview, a terrain subview, and a facility subview. In accordance with an embodiment of the present invention, the circles on the left side of the display of the mobile device 200 correspond to the numerous subviews within the map screen. In order to navigate from the first subview as indicated by the displayed circle on the bottom left of the mobile display screen, the user simply tilts the mobile device forward once. To navigate from this subview to the next subview, the user again tilts the mobile device forward once. To navigate backward through the subviews, the user tilts the mobile device backward. These functional subviews, as represented by the circles on the bottom left of the mobile device screen, may be further customized by replacing the circle graphics with icons that depict the functional subviews they represent.

In general, navigating between functional subviews (e.g., ski runs, lifts, terrain, facilities) within a particular functional view (e.g., map view), the user tilts the mobile device forward or backward according to the position of the subview icon shown on the display. In this manner, the positions of the subview icons on the display correlate in an intuitive manner to the gestures to be made by the user to navigate to another subview. That is, the user is intuitively cued by the displayed icons. Similarly, to navigate between main functional views (e.g., map, friend locator, local advice, weather, camera), the user tilts the mobile device 200 left or right. The positions of the view icons on the display correlate in an intuitive manner to the gestures to be made by the user to navigate to another view.

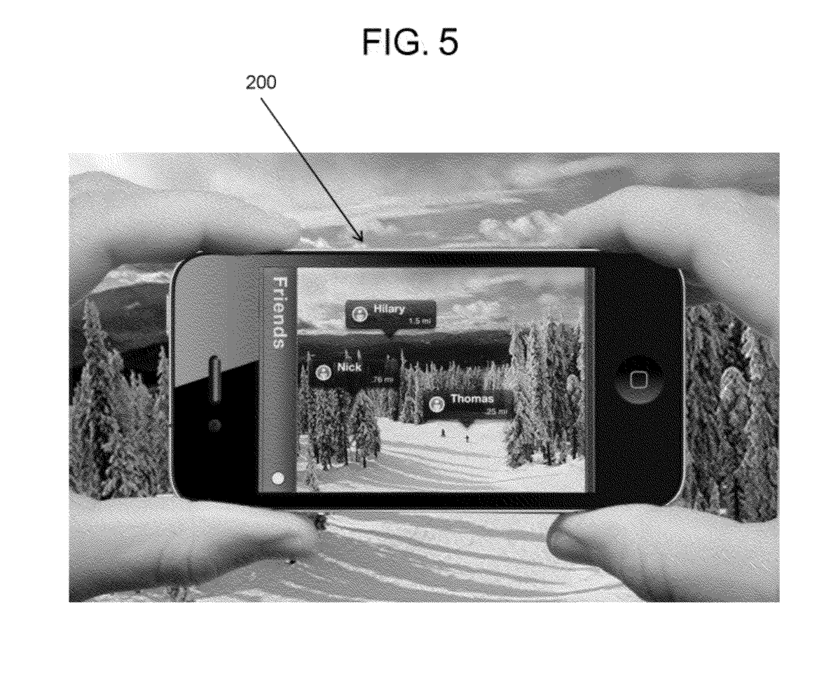

FIG. 5 illustrates an exemplary embodiment of a front view of a mobile device 200 running the mobile application 100 of FIG. 1, and being used in an augmented reality friends view of the application 100. The friends view shows icons representing locations of friends (e.g., Hilary, Nick, and Thomas) overlaid onto the real time video on the display of the mobile device. Again, the application 100 may rely on GPS capability of the mobile devices of the user and the friends to properly position the friend icons on the display screen based on the actual locations of the friends relative to the user. In the friends view of FIG. 5, the displayed color bars on the right represent the additional “folded” views (local advice, weather, and camera), and the displayed color bar on the left represents the “folded” map view.

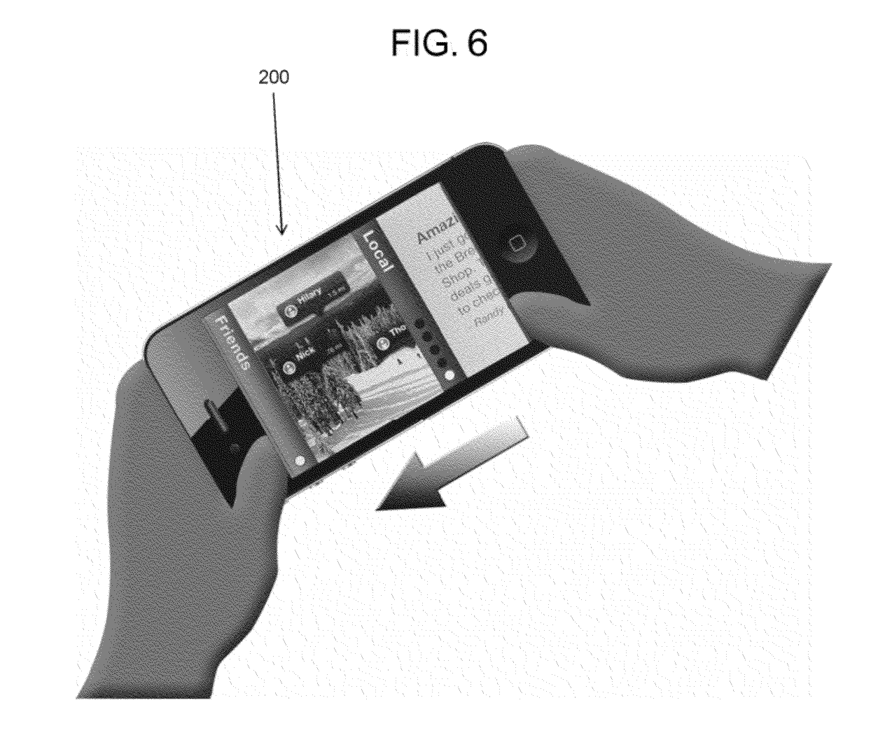

FIG. 6 illustrates an exemplary embodiment of a user interface used in collaboration with the gestural navigation system and how the user interface responds in an accordion type manner based on the gestures initiated by the user. By tilting the mobile device 200 to the left or right, the user can navigate from one functional view to another, as illustrated in FIG. 6. In FIG. 6 the user is currently switching from the friends view to the local advice view by tilting the mobile phone to the left. In the local advice view, a community of application users may provide text information about the ski resort where the user is currently located, for example. Other types of text information may be provided as well. In accordance with an embodiment of the present invention, additional subviews are included within the local advice view, as indicated by the icons on the left side of the display. Within the local advice view, the additional subviews could include additional posts from the community of users who have posted information to the application. Again, the user may navigate to a different functional subview by tilting the mobile device forward or backward, in correlation with the position of the subview icons on the display of the mobile device 200.

FIG. 6 illustrates the friend locator view and the local advice view of the application 100. These main functional features are indicated by vertical color bars displayed on the mobile device display screen. By tilting the mobile device 200 once to the left, the user can navigate from the friends view to the local advice view. When this is done, the friends view folds up to the left (in an accordion manner) on the display and forms a vertical colored bar indicating that, to get back to the friends view, the user must tilt the mobile device to the right. Also, the vertical color bars on the right represent the other main screens, including local advice, weather, and camera screens, which unfold toward the left (in an accordion manner) to display each view. In accordance with an alternative embodiment of the present invention, the results of the left and right tilting can be reversed, if this would be more intuitive to a user.

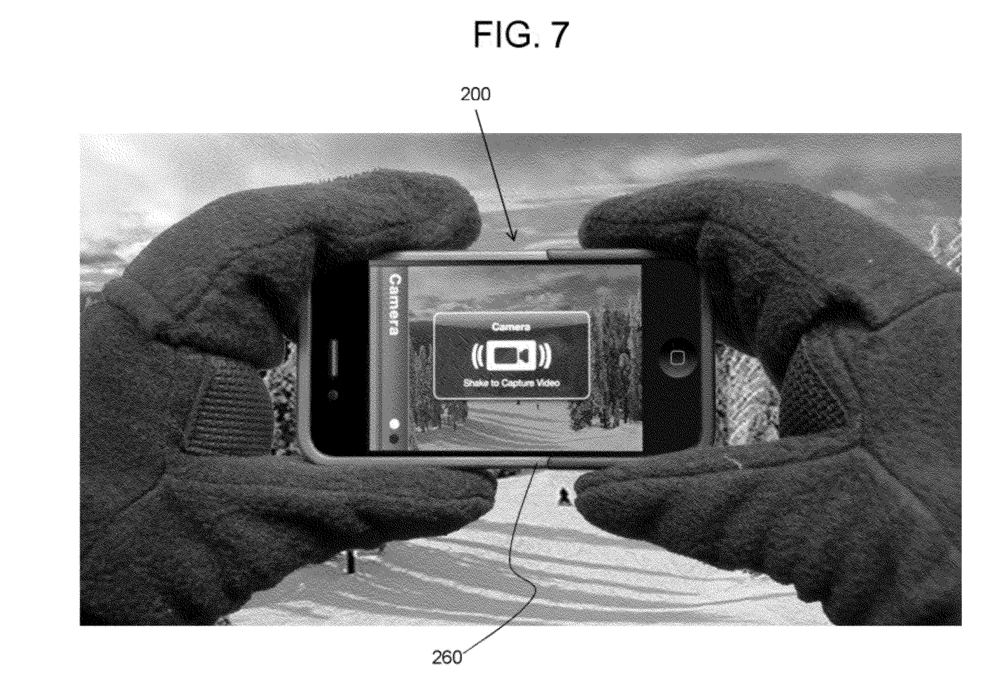

FIG. 7 illustrates an exemplary embodiment of a front view of a mobile device 200 completely sealed in a protective case or housing 260, being operated by a user wearing gloves, while running the mobile application of FIG. 1 and being used in an augmented reality camera view of the application. As illustrated in FIG. 7, the photo camera subview of the camera screen may access, for example, the standard camera of the mobile phone. However, instead of being operated by standard touch inputs, the photo camera is operated solely with gestures. Once the user settles on the photo camera subview of the camera screen, the user simply shakes the mobile device to take a photo. Once the user shakes the device, the user would then be prompted with a countdown (time to stabilize the device) after which the mobile device would capture the photo. The video camera subview of the camera screen may access, for example, the standard mobile phone video camera. This would function much like the photo camera subview, where the user settles on the video camera subview, then shakes the mobile device to start recording. They would then shake the mobile device again to stop recording.

This gestural navigation system allows users to keep their gloves on while operating their mobile device. This proves especially beneficial in inclement weather where removing gloves can prove dangerous or impossible. Sealing the mobile device in a protective case, while still being able to operate the application at hand, also proves very beneficial in protecting the device from harsh elements found within the surrounding environment. This also allows the user to take the phone into many additional environments, that otherwise would be too dangerous or risky, such as while kayaking, or in the rain, where an unprotected mobile device would be damaged by the elements within the wild environment.

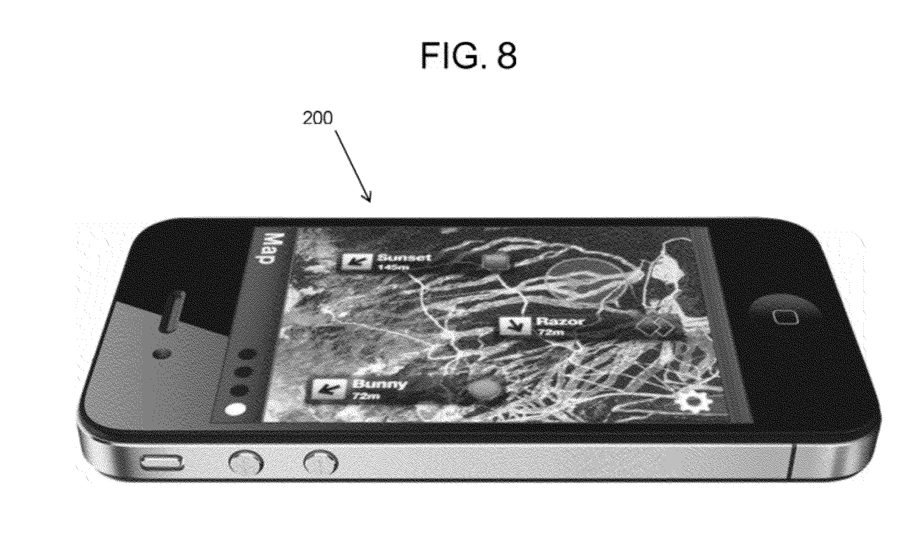

FIG. 8 illustrates an exemplary embodiment of a view seen when the application of the mobile device is put into the desktop mode, where touch navigation is the primary input mechanism. Although this navigation scheme is based around gestures, touch interaction is not completely removed for environments that facilitate this type of interaction. Not all wild environments are the same. Some will allow for more touch interaction than others, so the desktop mode (touch interaction) aspect of the navigation system could be applied to applications when necessary. In very harsh wild environments, touch interaction becomes ineffective or impossible, so the scheme for those applications would rely solely on gestural input. The desktop mode involving touch interaction may be added to an application that is being used in an environment, and during an activity that would allow for touch interaction.

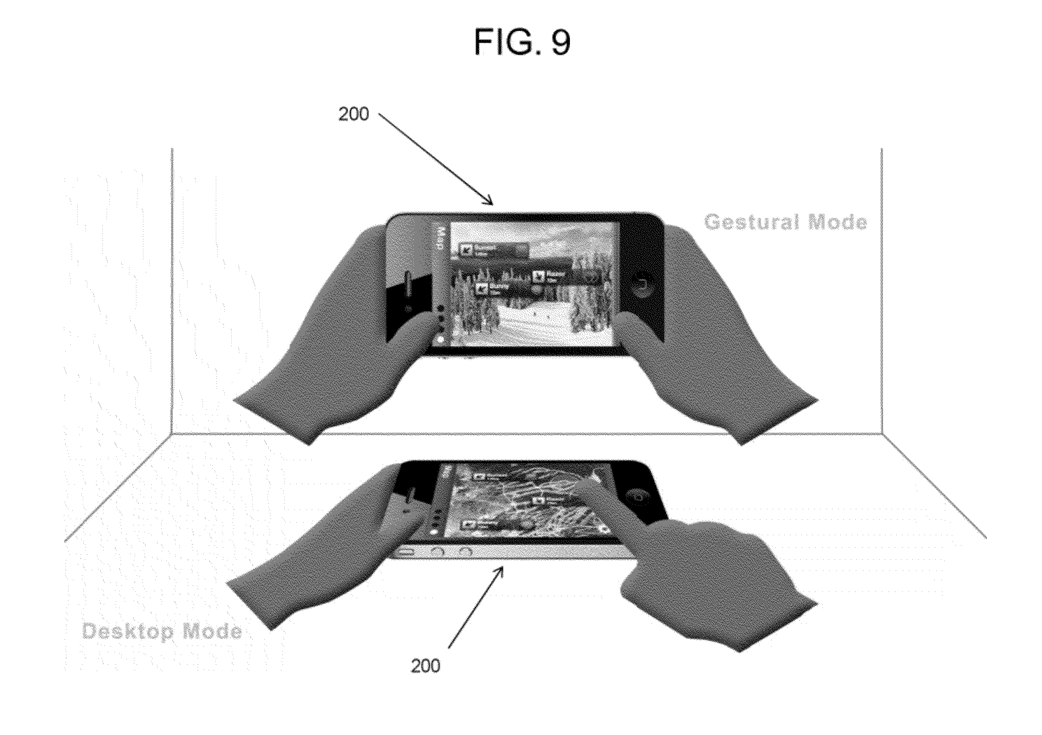

FIG. 9 illustrates exemplary embodiments of functional views displayed when the mobile device is put in the desktop mode verses the gestural mode. Two views are displayed when the mobile device is put in a desktop mode verse a gestural mode, which is determined by the z-axis tilt of the mobile device. The device is in gestural mode when the side opposite the screen of the mobile device is held perpendicular to the ground. The device is in desktop (touch) mode when the side opposite the screen of the mobile device is held flat to the ground. These benchmarks of holding the device perpendicular or parallel to the ground to switch between the desktop mode and the gestural mode have been applied to the exemplary embodiment of the mobile application of FIG. 1. However, the degree to which the z-axis of the mobile device is to change to trigger these modes may vary based on what may be appropriate for the application, activity, and environment at hand.

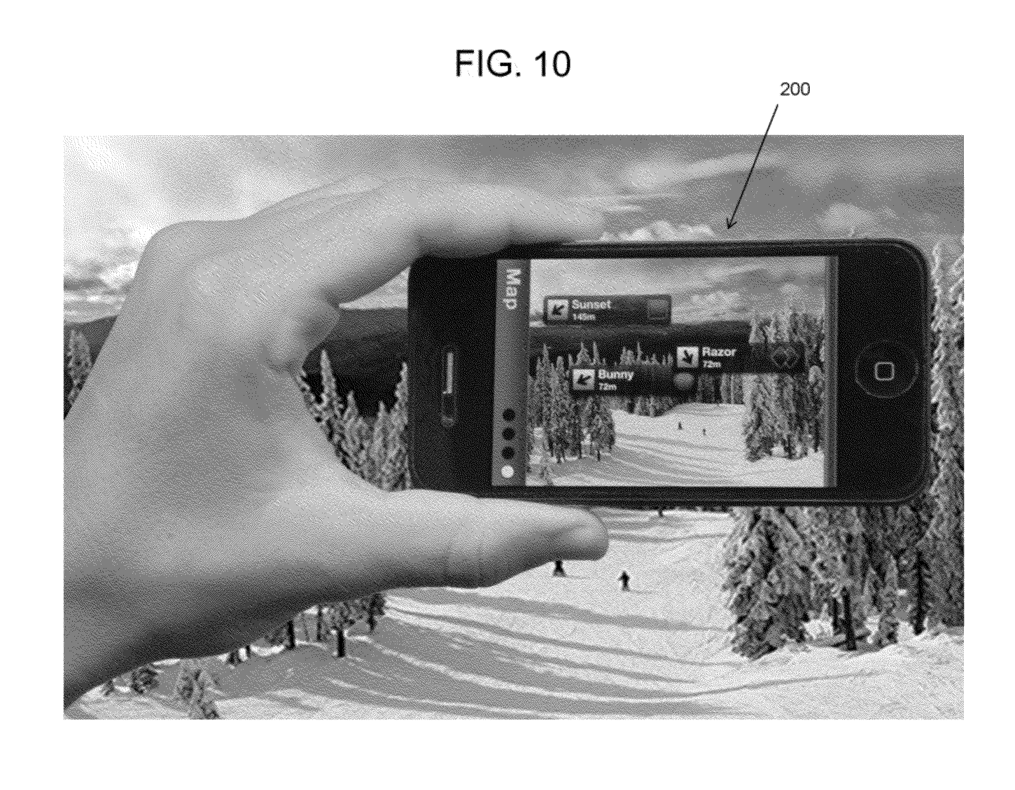

FIG. 10 illustrates an exemplary embodiment of a front view of a mobile device 200 being operated with one hand, running the mobile application 100 of FIG. 1 and being used in an augmented reality map view of the application. The ability of the gestural navigation scheme to be operated with one hand differentiates it from traditional application navigation schemes that typically rely on touch input. These traditional touch navigation schemes require the user to hold the mobile device in one hand, while they use the other hand to interact with the touch screen. The gestural navigation scheme removes this usability issue by allowing the user to navigate all application functions with one hand. This proves especially beneficial in environments that require the user to hold equipment or other related materials in one hand, leaving them only one other hand free to operate the mobile device. An example of this would include a kayaker kayaking down a river. The kayaker would need to hold his or her kayaking paddle in one hand, while holding the mobile device in the other. An additional example includes skiers standing at the top of a ski run with their ski poles in one hand, and their mobile devices in the other.

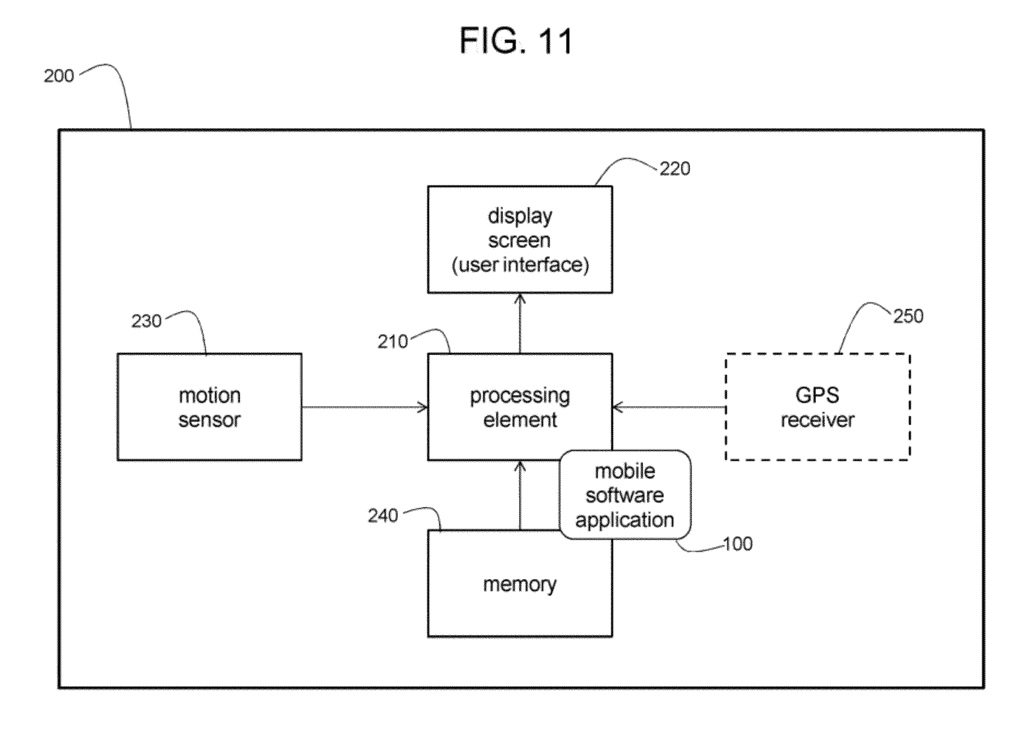

FIG. 11 illustrates a schematic block diagram of an exemplary embodiment of a mobile device 200 configured to run the mobile application 100 of FIG. 1. The mobile device 200 includes a processing element (e.g., a programmable microprocessor) 210. The mobile device 200 also includes a display screen 220 operatively connected to the processing element 210 and operatively configured to display information produced by a software application 100 as the software application operates on the processing element 10. The display screen 220 may be a liquid crystal display (LCD) screen or a light-emitting diode (LED) display screen, for example. Other types of display screens are possible as well, in accordance with various other embodiments of the present invention.

The mobile device 200 also includes a motion sensor 230 operatively connected to the processing element 210. The motion sensor 230 senses the gestures imposed on the mobile device 200 by a user and provides signals or data representative of the sensed gestures to the processing element 210. The motion sensor 230 may be an accelerometer or a gyroscope, for example. Other types of motion sensors are possible as well, in accordance with various other embodiments of the present invention.

The mobile device 200 also includes a mobile software application 100 configured to operate on the processing element 210 to provide functionality (e.g., the functionality outlined in FIG. 1). The software application 100 is in the form of a plurality of computer instructions and data, in accordance with an embodiment of the present invention, providing a functionality via selectable functions. For example, the software application 100 may provide functionality that aids a skier or a snowboarder at an outdoor facility. Referring to FIG. 1, the selectable functionality of the software application 100 may include a map functionality, a friends location functionality, a local information functionality, a camera functionality, and a weather information functionality. The mobile device 200 also includes a computer memory 240 operatively connected to the processing element 210. The computer memory 240 may be used to store the software application 100, as well as other instructions and data.

The software application 100 is configured to display representations of the selectable functions on the display screen 220 (as previously described herein) to intuitively cue a user as to which of the defined gestures to impose on the mobile device 200 to navigate to a desired function of the selectable functions. The software application 100 is also configured to correlate the sensed gestures, as represented by the data received from the motion sensor 230 by the processing element 210, to the selectable functions in accordance with the intuitive cueing of the user by the displayed representations.

As an option, the mobile device 200 may includes a global positioning system (GPS) receiver 250 operatively connected to the processing element 210 and operatively configured to provide GPS location information to the processing element 210. The GPS location information may be used, for example, by the friends location functionality of the software application 100 to identify a location of the user of the mobile device 200 with respect to the location of friends at a ski resort. In accordance with an embodiment, the software application 100 is configured to operate on the mobile device 200 to receive GPS location information of the friends. Other uses of the GPS information by the software application 100 are possible as well, in accordance with various embodiments of the present invention.

The mobile device 200 also includes a protective housing 260 (see FIG. 7) configured to protect the various elements (e.g., display screen, motion sensor, processing element, memory, GPS receiver) of the mobile device 200 from environmental factors (e.g., moisture, vibration, shock, heat, cold). In accordance with an embodiment of the present invention, the protective housing 260 is made of various types of plastic materials, but may be made of other protective materials as well.

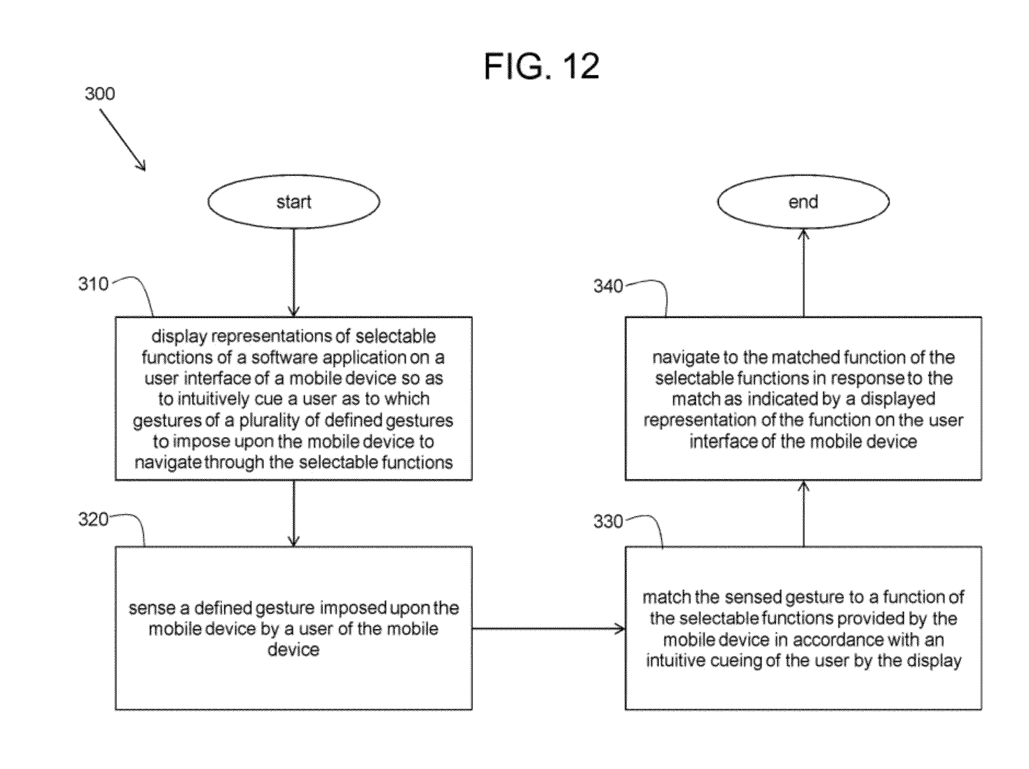

FIG. 12 is a flowchart of an exemplary embodiment of a method 300 implemented in a software application 100 on a mobile device 200 providing a gesture navigation scheme. In step 310, the method includes displaying representations of selectable functions of the software application on a user interface of the mobile device so as to intuitively cue a user as to which gestures of a plurality of defined gestures to impose upon the mobile device to navigate through the selectable functions. In step 320, the method includes sensing a defined gesture imposed upon the mobile device by a user of the mobile device. In step 330, the method includes matching the sensed gesture to a function of the selectable functions provided by the mobile device in accordance with an intuitive cueing of the user by the display. In step 340, the method includes navigating to the matched function of the selectable functions in response to the match as indicated by a displayed representation of the function on the user interface of the mobile device. The method may further include selecting the matched function on the mobile device in response to the user imposing a defined selection gesture on the mobile device. Again, the concept of “intuitive cueing”, as used herein, refers to a user being readily able to understand which gesture or gestures to make to navigate to a function of the software application of the mobile device simply by observing the spatial relationships of the displayed portions of the user interface of the mobile device.

An embodiment of the present invention includes a non-transitory computer-readable medium such as, for example, a magnetic disk, a magnetic tape, a magnetic drum, punched cards or paper tapes, an optical disk, a bar code, and magnetic ink characters. Other types of non-transitory computer-readable media are possible as well. The non-transitory computer-readable medium has at least computer-executable instructions of the software application 100 recorded thereon. The computer-executable instructions are capable of being executed by the processing element 210 of the mobile device 200.

In summary, systems and methods to facilitate the navigation of features of an application of a mobile device using a gestural input scheme are disclosed. A mobile device having a motion sensor such as, for example, an accelerometer or a gyroscope is programmed with an application that allows a user to navigate between the various functions (features, screens, and menu options) of the application by moving the mobile device according to predefined gestures. The motion sensor in the mobile device senses a user gesture imposed on the mobile device and the application on the mobile device responds to the gesture by performing the navigation function that is correlated to the gesture as part of the application.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiments disclosed, but that the claimed subject matter will include all embodiments falling within the scope of the appended claims.

What is claimed is:

1. A method implemented in a software application on a mobile device providing a gesture navigation scheme, said method comprising:
displaying representations of selectable functions of the software application on a user interface of the mobile device so as to intuitively cue a user as to which gestures of a plurality of defined gestures to impose upon the mobile device to navigate through the selectable functions;
sensing a defined first gesture imposed upon the mobile device by a user of the mobile device;
matching the first gesture to a first function of the selectable functions provided by the mobile device in accordance with an intuitive cueing of the user by the displaying; and
navigating to the first function of the selectable functions in response to the matching as indicated by a displayed representation of the first function on the user interface of the mobile device.

2. The method of claim 1, further comprising selecting the first function on the mobile device in response to the user imposing a defined selection gesture on the mobile device.

3. The method of claim 1, further comprising:
sensing a defined second gesture imposed upon the mobile device by a user of the mobile device;
matching the second gesture to a second function of the selectable functions provided by the mobile device in accordance with an intuitive cueing of the user by the displaying; and
navigating to the second function of the selectable functions in response to the matching as indicated by a displayed representation of the second function on the user interface of the mobile device.

4. The method of claim 3, further comprising selecting the second function on said mobile device in response to the user imposing a defined selection gesture on the mobile device.

5. The method of claim 1, wherein the selectable functions of the software application provide functionality to aid at least one of a skier user and a snow-boarder user at an outdoor facility.

6. The method of claim 1, wherein the selectable functions correspond to one or more of a map functionality of the software application, a friends location functionality of the software application, a local information functionality of the software application, a camera functionality of the software application, and a weather information functionality of the software application.

7. A mobile device providing a gesture navigation scheme, said mobile device comprising:
at least one motion sensor configured to sense one or more defined gestures imposed upon the mobile device by a user of the mobile device;
a processing element operatively configured to receive data indicative of the sensed gestures from the at least one motion sensor;
a software application configured to operate on the processing element to provide selectable functions; and
a display screen operatively configured to display information produced by the software application as the software application operates on the processing element,
wherein the software application is further configured to:
display representations of the selectable functions on the display screen to intuitively cue a user as to which of the defined gestures to impose on the mobile device to navigate to a desired function of the selectable functions, and
correlate the sensed gestures, as represented by the received data, to the selectable functions in accordance with the intuitive cueing of the user by the displayed representations.

8. The mobile device of claim 7, further comprising a global positioning system (GPS) receiver operatively configured to provide GPS location information to the processing element.

9. The mobile device of claim 7, wherein the selectable functions of the software application provide functionality to aid at least one of a skier user and a snow-boarder user at an outdoor facility.

10. The mobile device of claim 7, wherein the selectable functions correspond to one or more of a map functionality of the software application, a friends location functionality of the software application, a local information functionality of the software application, a camera functionality of the software application, and a weather information functionality of the software application.

11. The mobile device of claim 7, further comprising a protective housing configured to protect at least the at least one motion sensor, the processing element, and the display screen from environmental factors.

12. The mobile device of claim 11, wherein the environmental factors include one or more of moisture, vibration, shock, heat, and cold.

13. The mobile device of claim 7, further comprising computer memory for storing at least computer-readable instructions of the software application.

14. The mobile device of claim 7, wherein the motion sensor includes at least one of an accelerometer and a gyroscope.

15. The mobile device of claim 7, wherein the processing element includes a microprocessor.

16. The mobile device of claim 7, wherein the display screen includes one of an liquid crystal display (LCD) screen and a light-emitting diode (LED) display screen.

17. A non-transitory computer-readable medium having computer-executable instructions of a software application recorded thereon, said computer-executable instructions capable of being executed by a processing element of a mobile device and providing a gesture navigation scheme on the mobile device, said instructions comprising:
instructions providing selectable functions of a software application;
instructions for displaying representations of the selectable functions of the software application on a user interface of the mobile device so as to intuitively cue a user as to which gestures of a plurality of defined gestures to impose upon the mobile device to navigate through the selectable functions;
instructions for identifying a defined gesture imposed upon the mobile device by a user of the mobile device; and
instructions for matching the identified gesture to a first function of the selectable functions provided by the software application in accordance with an intuitive cueing of the user by the displayed representations.
instructions for navigating to the first function of the selectable functions in response to the matching as indicated by a displayed representation of the first function on the user interface of the mobile device.

18. The non-transitory computer-readable medium of claim 17, wherein the instructions further comprise instructions for selecting the first function on the mobile device in response to the user imposing a defined selection gesture on the mobile device.

19. The non-transitory computer-readable medium of claim 17, wherein the selectable functions of the software application provide functionality to aid at least one of a skier user and a snow-boarder user at an outdoor facility.

20. The non-transitory computer-readable medium of claim 17, wherein the selectable functions correspond to one or more of a map functionality of the software application, a friends location functionality of the software application, a local information functionality of the software application, a camera functionality of the software application, and a weather information functionality of the software application.
